(19) United States
(12) Patent Application Publication
(10) Pub. No.: US 2015/0363754 A1
(43) Pub. Date: Dec. 17, 2015

(54) VIRTUAL CARD NUMBER BASED PERSON-TO-PERSON PAYMENTS

(71) Applicant: MasterCard International Incorporated, Purchase, NY (US)

(72) Inventors: Adam Kenneth Hosp, Lake St. Louis, MO (US); David Colby Brown, Dardenne Prairie, MO (US)

(21) Appl. No.: 14/717,113

(22) Filed: May 20, 2015

Related U.S. Application Data
(60) Provisional application No. 62/011,915, filed on Jun. 13, 2014.

(51) Int. Cl. G06Q 20/10; G06Q 10/10; G06Q 20/32; G06Q 20/34

(52) U.S. Cl. CPC G06Q 20/108; G06Q 20/34; G06Q 10/107; G06Q 20/3221; G06Q 20/3255

(57) ABSTRACT

A method includes receiving, in a computer, a request for a funds transfer from a sender to a recipient. The method also includes sending, from the computer, a message to the recipient. The message indicates to the recipient that the funds transfer has been made and that the recipient has a number of options for receiving the funds transfer. The method further includes receiving, in the computer, from the recipient, an indication for indicating selection of one of the options for receiving the funds transfer.

### CROSS REFERENCE TO RELATED APPLICATION

This application claims the benefit of U.S. Provisional Patent Application No. 62/011,915 filed on Jun. 13, 2014, the contents of which application are hereby incorporated by reference for all purposes.

### BACKGROUND

It has previously been proposed to utilize a payment card account system to implement person-to-person payments. One such system is disclosed in U.S. Pat. No. 8,271,362, which is assigned to MasterCard International Incorporated, the assignee hereof.

The present inventors have recognized that there are opportunities for still greater convenience in utilizing a payment card account system to support person-to-person payments.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram representation of a person-to-person payment system provided in accordance with aspects of the present invention.

FIG. 2 is a block diagram representation of a financial institution (FI) server computer that is part of the system of FIG. 1.

FIG. 2A is a block diagram representation of a device that may be utilized by a recipient of a funds transfer in accordance with aspects of the present invention

FIGS. 3 and 4 are example screen displays that may be provided to a user of the system of FIG. 1 in accordance with aspects of the present invention.

FIG. 5 is a flow chart that illustrates a process that may be performed in the system of FIG. 1 in accordance with aspects of the present invention.

FIG. 6 is a flow chart that illustrates another process that may be performed in the system of FIG. 1 in accordance with aspects of the present invention.

### DETAILED DESCRIPTION

In general, and for the purpose of introducing concepts of embodiments of the present invention, an FI may provide services to facilitate a funds transfer from a sender to a recipient. The FI may receive the funds transfer request from the sender and then may provide a message to the recipient to provide the recipient with options for receiving the funds transfer. The options may be such that the recipient need not currently (i.e., prior to the funds transfer) be a customer of the FI. For example, the options may include receiving the funds in a newly issued payment card account identified by a new virtual card number.

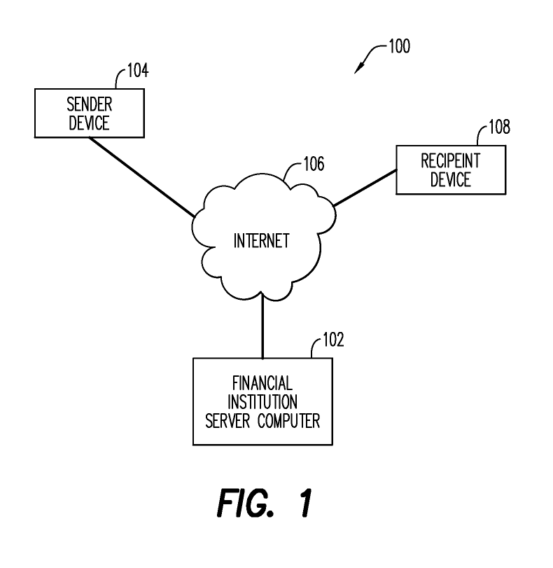

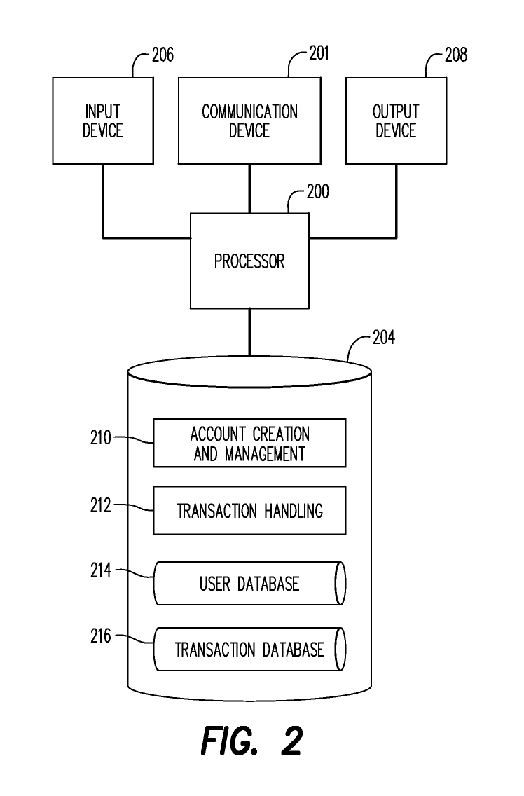

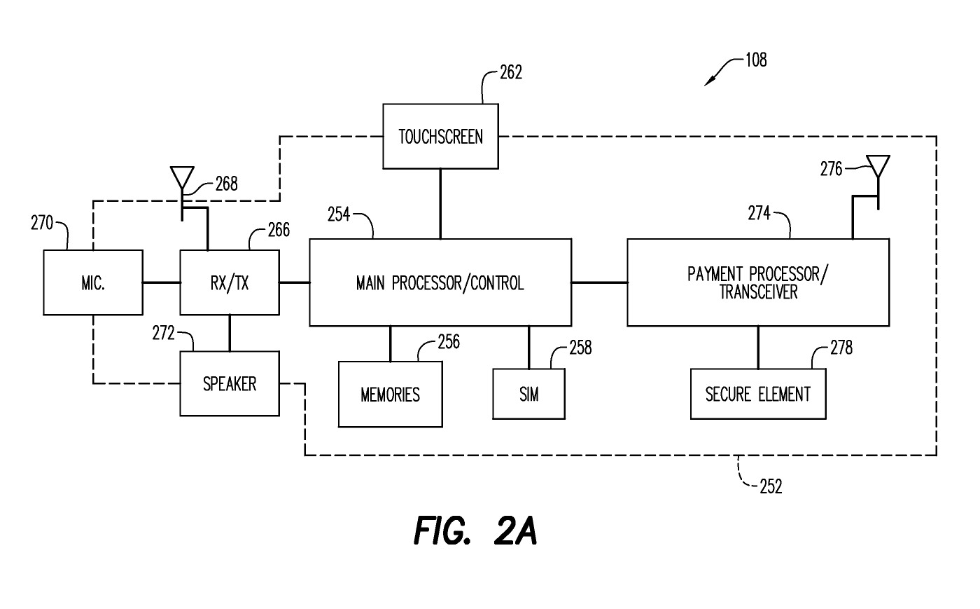

FIG. 1 is a block diagram representation of a person-to-person (P2P) payment system 100 provided in accordance with aspects of the present invention. One component of the system 100 may be an FI server computer 102. Details of the FI server computer 102 are described below in connection with FIG. 2.

The FI server computer 102 may host one or more websites that allow users to interact with the FI server computer 102. For example, a funds transfer sender (not shown) may use a sender device 104 to access the FI website via the internet 106. It may be assumed that the sender is an existing customer of the FI that operates the FI server computer 102. For example, the sender may previously have signed up for a P2P payment service offered by the FI. It may be assumed that the FI is an issuer of payment card accounts, along with providing other banking services as well.

As will be seen from subsequent discussion, there may also be communication via the internet 106 between the FI server computer 102 and a device 108 operated by the intended recipient of a funds transfer initiated by the sender. The recipient need not necessarily be a customer of the FI and/or a subscriber to the FI's P2P payment service at the time the sender initiates a funds transfer to the recipient.

Both the sender device 104 and the recipient device 108 may be largely or entirely conventional in both their hardware and software aspects. (However, in some embodiments, the sender device 104 may run an application that is specifically designed to facilitate the sender's use of the FI's P2P payment service. Moreover, in some embodiments, the recipient device may run, or have downloaded to it, an application to facilitate aspects of the present invention in accordance with some use-cases.) In some embodiments, both the sender device 104 and the recipient device 108 may be conventional mobile devices that run mobile browsers. For example, either one or both of the sender device 104 and the recipient device 108 may be smartphones, tablet computers, or the like. Alternatively, one or both of the sender device 104 and the recipient device 108 may be a conventional personal computer, laptop computer, etc. In a case where the sender device 104 or the recipient device 108 is a mobile device, communication to and from such devices may include operation of one or more mobile networks (not shown), which may provide access to the internet 106.

The components of the system 100 as depicted in FIG. 1 are only those that are needed for processing a single funds transfer transaction. A practical embodiment of a P2P payments system according to aspects of the invention may perform many such transfers, including simultaneous transfer transactions, and may include numerous sender and recipient devices. The P2P payments system may also operate in connection with one or more payment card account systems, which are not shown. Once such system is operated by MasterCard International Incorporated, which is the assignee hereof.

FIG. 2 is a block diagram that illustrates an embodiment of the FI server computer 102 shown in FIG. 1.

The FI server computer 102 may be conventional in its hardware aspects but may be controlled by software to cause it to function as described herein. For example, the FI server computer 102 may be constituted by conventional server computer and/or mainframe computer hardware.

The FI server computer 102 may include a computer processor 200 operatively coupled to a communication device 201, a storage device 204, an input device 206 and an output device 208.

The computer processor 200 may be constituted by one or more conventional processors. Processor 200 operates to execute processor-executable steps, contained in program instructions described below, so as to control the FI server computer 102 to provide desired functionality.

Communication device 201 may be used to facilitate communication with, for example, other devices (such as sender and recipient devices). For example communication device 201 may comprise numerous communication ports (not separately shown), to allow the FI server computer 102 to communicate simultaneously with a number of other devices and computers, including communications as required to receive and execute requests for P2P funds transfers.

Input device 206 may comprise one or more of any type of peripheral device typically used to input data into a computer. For example, the input device 206 may include a keyboard and a mouse. Output device 208 may comprise, for example, a display and/or a printer.

Storage device 204 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 204 stores one or more programs (discussed in somewhat more detail below) for controlling processor 200. The programs comprise program instructions (which may be referred to as computer readable program code means) that contain processor-executable process steps of the FI server computer 102, executed by the processor 200 to cause the FI server computer 102 to function as described herein.

The programs stored in the storage device 204 may include one or more conventional operating systems (not shown) that control the processor 200 so as to manage and coordinate activities and sharing of resources in the FI server computer 102, and to serve as a host for application programs that run on the FI server computer 102.

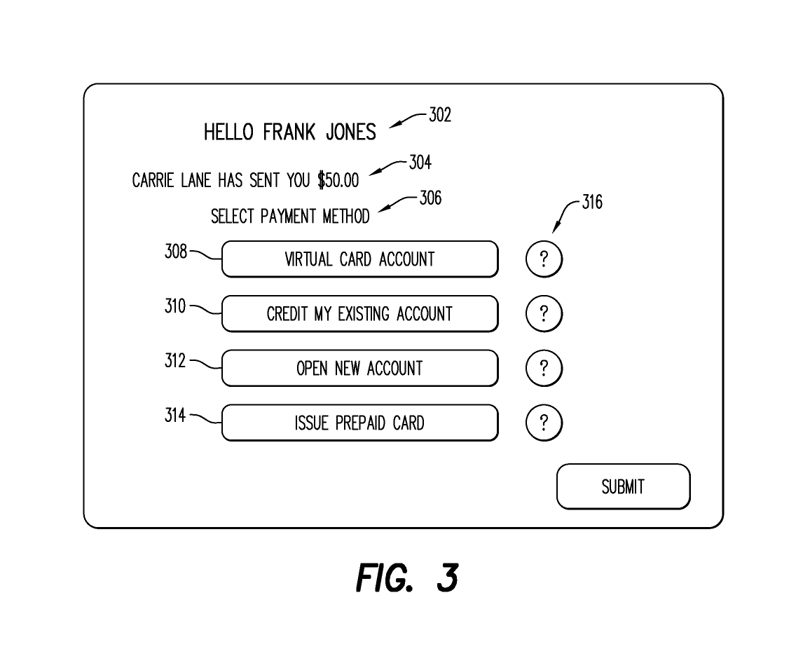

The programs stored in the storage device 204 may also include an account creation and management application program 210 that allows senders to establish user accounts for the P2P payments service and to update and manage their accounts. The programs stored in the storage device 204 may further include a transaction handling application program 212 that includes functionality as described below in connection with FIGS. 3-5; this functionality may allow the FI server computer 102 to handle funds transfer transactions in accordance with aspects of the present invention.

Other programs stored in the storage device 204 may include a reporting application, which may respond to requests from system administrators for reports on the activities performed by the FI server computer 102. The other programs may also include, e.g., website hosting software, communication software, one or more database management programs, device drivers, etc.

The storage device 204 may also store a user database 214. The user database 214 may allow the FI server computer 102 to store accounts maintained for enrolled users in the FI's P2P payment service. The storage device 204 may also store a transaction database 216 which stores funds transfer transaction data and data that reflects issuance of payment card accounts. Additional databases as required for operation of the FI server computer 102 may also be stored in the storage device 204.

FIG. 2A is a block diagram that illustrates an example embodiment of the recipient device 108 shown in FIG. 1 and provided in accordance with aspects of the present invention. This example of the recipient device is presented with the assumption that it is embodied as a smartphone. Accordingly, the device illustrated in FIG. 2A may sometimes be referred to as “smartphone 108”. As noted above, the recipient device may alternatively be embodied as another type of device with computing capabilities, including for example a capability for running a browser program.

The smartphone 108 may resemble, in some or all of its hardware aspects and many of its functions, common commercially available smartphones. In some embodiments, and as illustrated herein, the smartphone 108 may include capabilities for engaging in payment transactions at a point of sale. However, other embodiments may lack such capabilities.

The smartphone 108 may include a conventional housing (indicated by dashed line 252 in FIG. 2A) that contains and/or supports the other components of the smartphone 108. The housing 252 may be shaped and sized to be held in a user's hand, and may for example exhibit the type of form factor that is common with the current generation of smartphones.

The smartphone 108 further includes conventional control circuitry 254, for controlling over-all operation of the smartphone 108. For example, the control circuitry 254 may include a conventional processor of the type designed to be the “brains” of a smartphone.

Other components of the smartphone 108, which are in communication with and/or controlled by the control circuitry 254, include: (a) one or more memory devices 256 (e.g., program and working memory, etc.); (b) a conventional SIM (subscriber identification module) card 258; (c) a conventional touchscreen 262 which serves as the primary input/output device for the smartphone 108, and which thus receives input information from the user and displays output information to the user. As is the case with many models of smartphones, in some embodiments the smartphone 108 may also include a few physically-actuatable switches/controls (not shown), such as an on/off/reset switch, a menu button, a “back” button, a volume control switch, etc. It may also be the case that the smartphone 108 includes a conventional digital camera, which is not shown.

The smartphone 108 also includes conventional receive/transmit circuitry 266 that is also in communication with and/or controlled by the control circuitry 254. The receive/transmit circuitry 266 is coupled to an antenna 268 and provides the communication channel(s) by which the smartphone 108 communicates via a mobile telephone communication network.

Continuing to refer to FIG. 2A, the receive/transmit circuitry 266 may operate both to receive and transmit voice signals, in addition to performing data communication functions. As is known to those who are skilled in the art, such data communication may be via HTTP (HyperText Transfer Protocol) or other communication protocol suitable for carrying out data communication over the internet.

The smartphone 108 further includes a conventional microphone 270, coupled to the receive/transmit circuitry 266. Of course, the microphone 270 is for receiving voice input from the user. In addition, a speaker 272 is included to provide sound output to the user, and is coupled to the receive/transmit circuitry 266.

The receive/transmit circuitry 266 may operate in a conventional fashion to transmit, via the antenna 268, voice signals generated by the microphone 270, and to reproduce, via the speaker 272, voice signals received via the antenna 268. The receive/transmit circuitry 266 may also handle transmission and reception of text messages and other data communications via the antenna 268.

The smartphone 108 may also include circuitry 274 that is partly or wholly dedicated to implementing NFC communications functionality of the smartphone 108. The smartphone 108 may further include a loop antenna 276, coupled to the NFC circuitry 274. In some embodiments, the NFC circuitry 274 may partially overlap with the control circuitry 254 for the smartphone 108. Moreover, the NFC circuitry 274 is associated with, and may also overlap with, a secure element 278 that is part of the smartphone 108 and is contained within the housing 252. The term “secure element” is well known to those who are skilled in the art, and typically refers to a device that may include a small processor and volatile and nonvolatile memory (not separately shown) that are secured from tampering and/or reprogramming by suitable measures. In some embodiments, the secure element 278 may be provided as part of the SIM card 258. In other embodiments, the secure element 278 may be constituted by an integrated circuit card separate from the SIM card 258 but possibly having the same form factor as the SIM card 258. In some embodiments, the secure element 278 may be provisioned or pre-programmed with one or more payment application programs (“apps”) such that the mobile device is enabled to operate as a payment device vis-à-vis POS terminals. For this purpose, the smartphone 108 may communicate with the POS terminals via the antenna 276 in accordance with the NFC communication standard.

It should also be understood that the smartphone 108 may be operable as a conventional mobile telephone for communication—both voice and data—over a conventional mobile telecommunications network. Thus, the smartphone 108 may be in communication from time to time in a conventional manner with a mobile network operator (“MNO”not shown).

As is familiar to those who are skilled in the art, the smartphone 108 may be viewed as a small computing device. The smartphone 108 may include one or more processors that are programmed by software, apps and/or other processor-executable steps to provide functionality as described herein. The software, apps and/or other processor-executable steps may be stored in one or more computer-readable storage media (such as the storage devices 256 and/or the secure element 278) and may comprise program instructions, which may be referred to as computer readable program code means. In some embodiments, the smartphone 108 may run a conventional mobile browser such that a user of the smartphone is enabled to interact with websites via the internet.

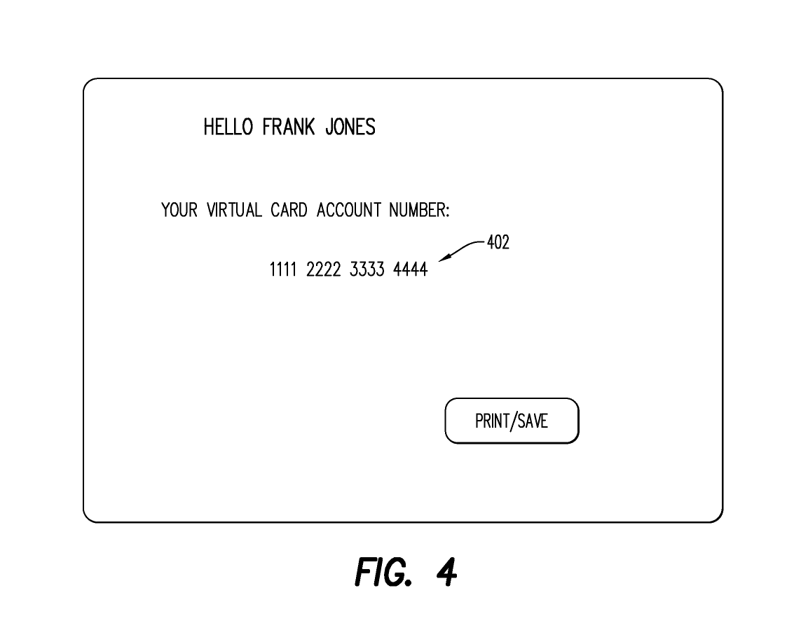

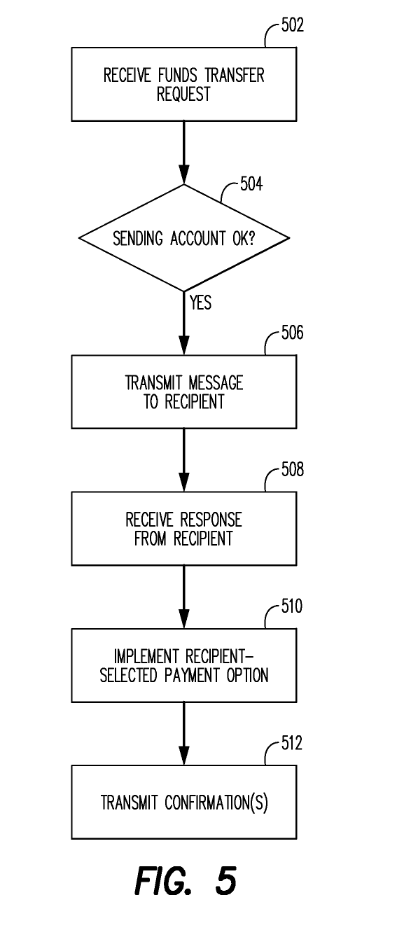

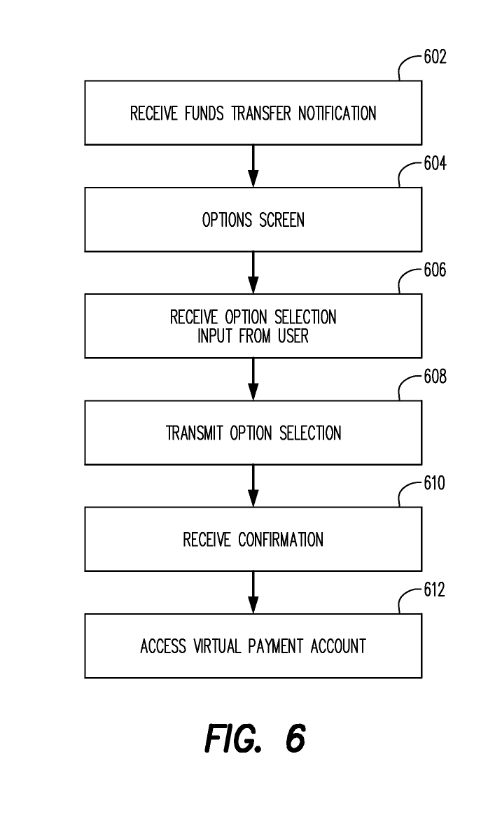

Processes that may be performed in the system 100 in accordance with aspects of the present invention will be described below in connection with FIGS. 5 and 6. First, however, the discussion will refer to FIGS. 3 and 4 to highlight aspects of the present invention relating to options provided to the funds transfer recipient.

For purposes of FIGS. 3 and 4, it will be assumed that the funds transfer sender has requested a funds transfer to the recipient by interacting with the FI server computer 102. FIGS. 3 and 4 are example screen displays that may be provided to the recipient via the recipient device 108 in accordance with aspects of the present invention. The recipient may or may not already be a customer of the FI.

Referring now to FIG. 3, the recipient is greeted at 302, and is informed at 304 that the sender has sent him/her a funds transfer. At 306, it is indicated to the recipient that he/she may select among a number of options regarding the manner in which he/she may receive the funds transfer. For example, a button 308 allows the recipient to select an option in which the proceeds of the funds transfer are used to fund a new payment card account that is identified by a new virtual payment card account number (“VCN”: virtual card number). If the recipient were to select this option, the new payment card account in question is immediately issued to the recipient by the FI, and the corresponding VCN is communicated to the recipient by the FI server computer 102 via, e.g., a screen display such as that shown in FIG. 4 (see VCN indicated at 402 in FIG. 4). The recipient may now immediately use the VCN to access the proceeds of the funds transfer by, for example, engaging in an online shopping transaction using the VCN or withdrawing cash from a suitably equipped ATM (not shown) using the VCN. This option may provide a high degree of convenience for the recipient, because the recipient need not be a previous customer of the FI, and need not enter into a banking relationship with the FI apart from becoming the holder of the payment card account represented by the VCN. This option also provides convenience for the sender, because the sender is enabled to make funds transfers via the P2P payment system to individuals who are not previously enrolled in the system and, indeed, who may not have a bank account or other financial account. Thus the P2P payment system is of increased value and usefulness to the sender, because the sender is not limited to making payments to current system members. As will be seen, all the sender needs to request a payment to the recipient is the recipient's name and some basic contact information such as the recipient's e-mail address and/or mobile phone number.

Referring again to FIG. 3, another option presented in some situations to the recipient is represented by button 310. Button 310 may only be included in the screen display if it is the case that the recipient already has a bank account with the FI. The option represented by button 310 is to have the proceeds of the funds transfer credited to the recipient's existing bank account.

Button 312 in FIG. 3 represents another option made available to the recipient. This option is for the recipient to open a new bank account (e.g., a demand deposit account) with the FI and to have the proceeds of the funds transfer credited to the new account.

Still another option provided to the recipient is represented by button 314 in FIG. 3. According to this option, the recipient may elect to have the proceeds of the funds transfer credited to a new payment card account, and for the FI to issue and mail a new physical payment card (e.g., a prepaid payment card) to the recipient to enable the recipient to access the payment card account via the physical card (e.g., via purchase transactions at retail stores).

The screen display of FIG. 3 may also include information request buttons 316, which may be provided to permit the recipient to request additional information or an explanation about each of the options represented by the buttons 308, 310, 312 and 314.

The number of options presented to the recipient via the screen display of FIG. 3 may be more or fewer than the four options indicated in the drawing. In some embodiments, only one option may be presented (e.g., the VCN/new payment card account). In some embodiments any one or more of the options depicted may not be present and/or may be replaced with another option, such as requesting that a paper check be issued and mailed to the recipient. Another possible option is that the recipient may request transfer of the proceeds to an account held by the recipient at another FI (which account may, e.g., be a demand deposit account or a payment card account). However, this may not be a preferred option for recipients, as they may be reluctant to disclose account information in response to an unsolicited message.

In addition to the display elements shown in FIGS. 3 and 4, the screen displays may include other elements, including for example branding elements for the FI and/or for the P2P payment service.

FIG. 5 is a flow chart that illustrates a process that may be performed in accordance with aspects of the present invention.

At 502 in FIG. 5, the FI server computer 102 may receive a request for a funds transfer by a sender. For example, this may occur by the sender using the sender device 104 to interact with the FI server computer 102. More specifically the sender may access a webpage hosted by the FI server computer 102 for a P2P payment service, and may sign in as a registered user of the service. The sender may designate the amount to be transferred, and also may designate the recipient by name and by contact information such as the recipient's e-mail address and/or mobile phone number. In some embodiments, the sender may also be enabled to select the funding account for the transfer from among a number of accounts that the sender holds and that have been previously linked to the sender's user account for the P2P payment service. In other embodiments or in other situations, the sender may have previously designated a specific account to serve as the funding account for all funds transfers to be made by the sender via the P2P payment service. The designated funding account may, for example, be a payment card account issued by the FI or a demand deposit account with the FI.

Decision block 504 may follow block 502 in FIG. 5. At decision block 504, the FI server computer 102 may determine whether the funding account is in good standing and holds sufficient funds or sufficient available credit to support the requested funds transfer. If the FI server computer 102 makes a positive determination at decision block 504, then block 506 may follow decision block 504.

At block 506, the FI server computer 102 may transmit a message to the recipient to indicate to the recipient that the funds transfer has occurred. This message may be, for example, an e-mail message or a text message, and may be transmitted by the FI server computer 102 to the recipient device 108 (or made available for retrieval by recipient device 108) using the recipient contact information supplied by the sender. The message may contain a link that points to a screen display, or otherwise may make available to the recipient device 108 a screen display, such as that shown in FIG. 3 and explained hereinabove. As noted in the above discussion of FIG. 3, the screen display presents options to the recipient for receiving the funds transfer.

The recipient may then select one of the options, and may transmit an indication of the selected option to the FI server computer 102. This may occur, for example, via interaction between the recipient device 108 and a webpage hosted by the FI server computer 102.

Block 508 in FIG. 5 represents the FI server computer 102 receiving the recipient's response to the message; i.e., receiving the indication of which option was selected by the recipient for payment of the transferred funds.

Block 510 may follow block 508 in the process of FIG. 5. At 510, the FI server computer 102 implements the option selected by the recipient, as indicated by the response received by the FI server computer 102 at 508. For example, if the recipient selected the VCN/payment card account option, and the sender had designated a payment card account as the funding account, then the funds transfer may be consummated like a substantially conventional payment-card-system-based P2P transfer where the same FI is the issuer of both the sending and receiving payment card accounts.

At 512, the FI server computer 102 may send one or more messages (e.g., to the sender and/or to the recipient) to confirm that the funds transfer has been completed. For example, in a case where the recipient has selected the VCN/payment card account option, the confirmation message may take the form of the screen display of FIG. 4, which may be served to and displayed by the recipient device 108.

FIG. 6 is a flow chart that illustrates another process that may be performed in the system 100 of FIG. 1 and more particularly by a recipient device 108.

At 602 in FIG. 6, the recipient device 108 may receive a notification (e.g., via email or text message) to notify the recipient that he/she is the beneficiary of a text message. At 604, the recipient device 108 may access a display page like that shown in FIG. 3. As noted above in the discussion of FIG. 3, the display page may present a number of options to the recipient as to how the recipient wishes to receive the funds transfer.

At 606, the recipient device 108 receives input from the recipient to indicate which option the recipient wishes to select from the options presented in the display page of FIG. 3. For example, in a case where the recipient device 108 is a smartphone, the recipient may make this indication by touching a corresponding virtual button on the touchscreen of the recipient device 108. An analogous manner of inputting the recipient's selection may occur in embodiments of the recipient device 108 that are not a smartphone.

At 608, the recipient device 108 may transmit data to the FI server computer 102 to indicate the option selected by the recipient from among the options presented at the display screen of FIG. 3. From the above discussion of FIG. 5, it will be appreciated that the processing described at blocks 508-512 of FIG. 5 may follow on the part of the FI server computer 102. Following block 512 of FIG. 5, the recipient device 108 may receive confirmation of the funds transfer (block 610, FIG. 6); for example, a display screen like that shown in FIG. 4 may be served to the recipient device 108 by the FI server computer 102.

In a use-case where the recipient has opted to receive a new virtual payment account to receive the funds transfer, the recipient may access the account by, e.g., conducting an online transaction utilizing the VCN. This process step, if it occurs, is represented by block 612 in FIG. 6.

In some use-cases, e.g., where the recipient device 108 is a smartphone, the screen display of FIG. 4 may be augmented with an offer from the FI server computer 102 to the recipient device 108 to download a mobile app (e.g., a payment application) to facilitate the recipient's access to the new virtual payment account via either or both of online purchase transactions and in store (POS) transactions. The latter option may only be feasible if the recipient device 108 is equipped with contactless payments capabilities such as those referred to above with respect to elements 274, 276 and 278 shown in FIG. 2A. In a case where the recipient device/smartphone 108 is not equipped to perform instore/POS payment transactions, the/an app downloaded to the recipient device/smartphone 108 from the FI server computer 102 may simply facilitate the recipient's storing and/or retrieving the VCN in connection with online e-commerce transactions. For example, such an app may facilitate the user in auto-filling the payment information page with the VCN during the checkout phase of an online purchase transaction.

In some embodiments, as noted above, the FI may offer only the option of issuance of a virtual account/VCN, and the display of FIG. 3 may be adapted accordingly, simply to notify the recipient and obtain the recipient's consent to issuance of the virtual account.

Considering some other use-cases, if the recipient opts to have a new payment card account issued by the FI with issuance of a physical (pre-paid) payment card, the interaction between the recipient device 108 and the FI server computer 102 may include the recipient sending his/her mailing address to the FI server computer 102 via the recipient device 108. Such an action may also be necessary if the recipient opts to receive a paper check from the FI, or to have a new deposit account opened at the FI. In the case of issuance of a physical payment card, the recipient may also be requested to supply his/her telephone number to aid in activating the pre-paid payment account once the recipient receives the physical card.

In some use cases, the sender may not be an individual. For example, processes like those described above could be used by a product manufacturer/distributor to fulfill a mail-in product rebate or the like. In other embodiments, individuals or other entities could employ the system 100 and the processes of FIGS. 5 and 6 to pay the recipient for services rendered to the sender.

In some embodiments, FI may engage in interactions with the funds transfer recipient to obtain identification and other information relative to the recipient. This may be done to satisfy regulations that require the FI to “know its customer”. In some embodiments, there may be little or no such interaction when the funds transfer is relatively small (and not part of a series of transfers), as applicable regulations and/or prudent banking practices may place very limited or no obligations on the FI in such situations to satisfy “KYC” (know your customer) requirements. For larger transactions, and/or for a sequence of transactions, the FI's practice may be to take significant steps to obtain identifying information with respect to the recipient and/or to screen the recipient.

In some embodiments, the FI may have procedures in place to deal with situations where the funds transfer recipient fails to respond to the notification provided to him/her about the available disbursement of the funds transfer. In some embodiments, for example, the FI may automatically cancel or reverse the funds transfer after a given period of time (e.g., seven days) after the notification if the recipient never takes the required step or steps for completing the funds transfer.

As used herein and in the appended claims, the term “computer” should be understood to encompass a single computer or two or more computers in communication with each other; and should also be understood to include any type of device with data processing capabilities, including server computers, mainframe computers, personal computers, laptop computers, tablet computers, smartphones and personal digital assistants.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” or “payment system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claim.

What is claimed is:

1. A method comprising:
receiving, in a computer, a request for a funds transfer from a sender to a recipient;
sending, from the computer, in response to the request, a message to the recipient, the message indicating to the recipient (i) that the funds transfer has been made; and (ii) that the recipient has a plurality of options for receiving the funds transfer; and
receiving, in the computer, from the recipient, an indication for indicating selection of one of said plurality of options.

2. The method of claim 1, wherein the plurality of options includes at least two of:
(a) crediting the funds transfer to a first payment card account identified by a virtual payment card account number;
(b) crediting the funds transfer to an existing demand deposit bank account that belongs to the recipient;
(c) opening a new demand deposit bank account and crediting the funds transfer to the new bank account; and
(d) crediting the funds transfer to a second payment card account and requesting issuance of a physical payment card for accessing the second payment card account.

3. The method of claim 2, wherein the plurality of options includes all of options (a), (b), (c) and (d).

4. The method of claim 1, wherein the message is sent from the computer to a device operated by the recipient, the device operated by the recipient being a device selected from the group consisting of: (a) a smartphone; (b) a tablet computer; (c) a laptop computer; and (d) a personal computer.

5. The method of claim 1, wherein the message to the recipient uses the recipient's email address as addressing information.

6. The method of claim 1, wherein the message to the recipient uses the recipient's mobile telephone number as addressing information.

7. A method comprising:
receiving, in a computer, a request for a funds transfer from a sender to a recipient;
sending, from the computer, in response to the request, a message to the recipient, the message indicating to the recipient (i) that the funds transfer has been made; and (ii) an offer to open a payment account for the recipient;
receiving, in the computer, the recipient's response to the offer;
opening the payment account for the recipient, the payment account identified by a virtual payment account number; and
communicating the virtual payment account number from the computer to the recipient.

8. The method of claim 7, wherein the message is sent from the computer to a device operated by the recipient, the device operated by the recipient being a device selected from the group consisting of: (a) a smartphone; (b) a tablet computer; (c) a laptop computer; and (d) a personal computer.

9. The method of claim 7, wherein the message to the recipient uses the recipient's email address as addressing information.

10. The method of claim 7, wherein the message to the recipient uses the recipient's mobile telephone number as addressing information.

11. The method of claim 7, wherein the offer indicates that the payment account to be opened is to be identified by a virtual payment account number.

12. A method comprising:
receiving, in a device, a message that indicates that a funds transfer has been made to a recipient;
transmitting, from the device, a request that (a) a payment account identified by a virtual payment account number be opened for the recipient; and (b) the funds transfer be credited to the payment account.

13. The method of claim 12, wherein (i) the payment account is a first payment account; and (ii) the message received in the device lists a plurality of options, the plurality of options including at least two of:
(a) crediting the funds transfer to the first payment account;
(b) crediting the funds transfer to an existing demand deposit bank account that belongs to the recipient;
(c) opening a new demand deposit bank account and crediting the funds transfer to the new bank account; and
(d) crediting the funds transfer to a second payment card account and requesting issuance of a physical payment card for accessing the second payment card account.

14. The method of claim 13, wherein the plurality of options includes all of options (a), (b), (c) and (d).

15. The method of claim 12, wherein the device is selected from the group consisting of: (a) a smartphone; (b) a tablet computer; (c) a laptop computer; and (d) a personal computer.

16. The method of claim 12, wherein the message is received from a server computer operated by a financial institution.

17. The method of claim 16, wherein the request is sent to said server computer.

18. The method of claim 12, further comprising:
after the transmitting step, receiving, by the device, the virtual payment account number.

19. The method of claim 18, wherein the virtual payment account number is received by the device as a text message.

20. The method of claim 18, wherein the virtual payment account number is received by the device as an email message.
